(19) United States
(12) Patent Application Publication
(10) Pub. No.: US 2024/0202197 A1
(43) Pub. Date: Jun. 20, 2024

(54) DISTRIBUTED DATA STORAGE USING MATERIALIZED INTERMEDIATE PARTITIONS

(71) Applicant: Microsoft Technology Licensing, LLC, Redmond, WA (US)

(72) Inventors: Ziqi MA, Bellevue, WA (US); Nirav Arvind KUNTAR, Gandhinagar (IN)

(21) Appl. No.: 18/067,128

(22) Filed: Dec. 16, 2022

(51) Int. Cl. G06F 16/2455; G06F 16/23; G06F 16/27

(52) U.S. Cl. CPC G06F 16/2456; G06F 16/2365; G06F 16/278

(57) ABSTRACT

A device and method for optimizing a merge operation via materialized intermediate partitions that maintains an internal state partitioned on merge-optimized key, which is different from read-optimized key in the read (final) copy. This method is designed to speed up merge operations on large scale data, where both storage and computation happen in distributed systems. When reading new data, the method is to first partitioned with merge key, then merge (e.g. upsert) with a previously materialized snapshot (which is the previous merge result), then materialize (still partitioned by mergekey) and overwrite relevant partitions in the read (final) copy, partitioned on read-optimized key. This reduces cross-network shuffle and significantly improves performance.

### BACKGROUND

Big data is usually stored in a distributed fashion in data lakes and lakehouses. Merge operations are frequently used to partially refresh data. One such example is the UPSERT operation, that updates data that is already present in the storage and inserts data into the delta table that is not already present. When data is stored in a distributed manner, such operations can be time-consuming because shuffles, i.e., data exchange, across the network are required. This is especially challenging when the read-partition key is different from the write-partition key, such as when the data is organized to enable efficient reads conflicts with processes for efficiently writing data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for optimizing a merge operation via materialized intermediate partitions is described. The method includes bucketing a first dataset in a database into a partition, the first dataset including a first value and a first iteration of a second value, wherein the second value is a feature of the first value, bucketing a second dataset in the database into the partition, the second dataset including the first value and a second iteration of the second value, wherein the second iteration of the second value is different than the first iteration of the second value, updating the partition to include the first value and the second iteration of the second value, and transmitting the updated partition to an external storage.

### BRIEF DESCRIPTION OF THE DRAWINGS

The present description will be better understood from the following detailed description read in light of the accompanying drawings, wherein:

FIG. 1 is a block diagram illustrating an example system for optimizing a merge operation:

FIG. 2 is a block diagram illustrating an example system for optimizing a merge operation:

FIG. 3 is a flowchart illustrating an example computerized method for optimizing a merge operation:

FIG. 4 is a flowchart illustrating an example computerized method for performing an update an insert operation:

FIG. 5 is a flowchart illustrating a computerized method for responding to a query using the partitioned data according to an example:

FIG. 6 illustrates example test results utilizing the optimized merge operation according to an example:

FIG. 7 illustrates example test results utilizing the optimized merge operation according to an example:

FIG. 8 illustrates example test results utilizing the optimized merge operation according to an example; and

FIG. 9 illustrates an example computing apparatus as a functional block diagram according to an example.

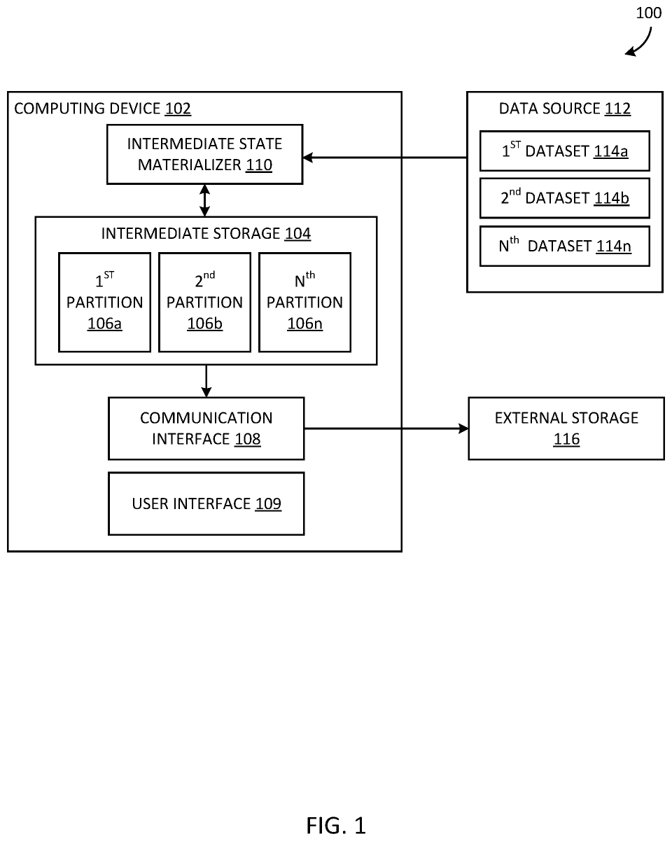

Corresponding reference characters indicate corresponding parts throughout the drawings. In FIGS. 1 to 9, the systems are illustrated as schematic drawings. The drawings may not be to scale. Any of the drawings may be combined into a single embodiment or example.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As new data to be stored in a dataset is received, the new data may include new values for existing identifiers in the dataset that are to be added to the data for a particular identifier, updated values for existing identifiers in the dataset that are to replace the existing data for the particular identifier, or entirely new data that does not correspond to data existing the dataset and therefore is to be newly added to the dataset. However, the process of merging the newly received data with an existing dataset is only applicable in certain scenarios and, if able to be executed, is prohibitively time-consuming and resource-consuming. For example, existing solutions include operations that are not supported where multiple source records match with a single target key, in other words, where the merge key is not unique. Even when able to be executed, due to the size of the datasets being merged, the existing solutions are unable to execute on a twenty-four or twelve-hour cadence due to the latency in performance.

Some current solutions include a delta merge operation that executes conditional delete, updates, insert, and UPSERT operations. However, delta merge is constrained because, as discussed above, the merge key is required to be unique in the source data. Thus, when multiple target records match a single source record, an update operation cannot be repeated and the command is unable to execute. An alternative is to delete all records from the existing data that appear in the new data and then append all new data, but this solution is also frequently unable to execute due to errors in or poor performance of the delete step leading to out-of-memory errors, and if a read occurs between the deletion of the existing data and the completion of appending the new data, incorrect and incomplete results are returned in response to the query.

Aspects of the disclosure provide an optimized merge operation that materializes intermediate partitions based on a merge key in the record. In some example, the merge key is a target identifier (ID) or a hash of multiple keys. The records stored in the dataset are partitioned based on a particular key, such as the merge key, such that all records having a particular merge key are stored together in a single partition. Because all records for the merge key are stored in the same partition, the existing data is quickly searchable to identify where an update or insert operation is to be performed. The partition infrastructure enables results to not only be returned more quickly and by using fewer computing resources than current solutions, but outputs data grouped in a particular format as requested in a query. In other words, the data is returned as grouped by the value requested to be returned. In addition, because the merge operation occurs separately from the read copy operation, from the read perspective, there is only an atomic single overwrite. This prevents incomplete results from being returned in the event of a query being received while the UPSERT operation is in the process of executing.

The system provided in the present disclosure operates in an unconventional manner at least by generating a partitioned intermediate state in which data records are stored in a particular partition based on the merge key. The partitioned intermediate state includes any number of partitions, which is tuned based on the number of merge keys distributed throughout the partitions. The partitioned infrastructure benefits the functioning of a computing device at least by reducing the consumption of computing resources and amount of time required to merge and update the dataset, as well as providing a new data structure that facilitates the retrieval of the data stored in the partition infrastructure in response to a query of the data. As described in greater detail below with regards to FIGS. 6-8, the partitioned infrastructure reduces the time and computing resources required to update and merge new datasets with existing datasets by up to three hundred eighty seven times.

As referenced herein, a merge operation includes an UPSERT operation. In other words, an UPSERT operation is one example of a broader merge operation. An UPSERT operation is a database operation in which an existing row in the database is updated with new, or updated, data if the specified value already exists, or a new row is inserted into the database if the specified value does not already exist, based on various conditions. As described herein, the UPSERT operation may be performed by any database that supports the UPSERT operation. The present disclosure does not limit the executability of the merge operation(s) described herein to any particular database, database structure, and so forth.

Aspects of the present disclosure provide a technical solution including a dynamically tunable, partitioned infrastructure that benefits the functioning of a computing device at least by reducing consumption of computing resources and the amount of time required to merge and update a dataset, as well as by providing a new data structure that facilitates retrieval of the data stored in the partition infrastructure in response to a query of the data. For example. FIGS. 6-8 described below illustrate various ratios of updating data relative to inserting data in an UPSERT operation, and the observed results showing the reduction in merge time. Less merge time equals reduced use of computational resources such as processing, storage, and network bandwidth.

As referenced herein, bucketing refers to a process by which data is sorted, or partitioned, into particular partitions. In bucketing, the data is allocated among a number of buckets, or partitions, based on values derived from bucketing columns. In so doing, data is shuffled and sorted prior to downstream operations being performed on or using the data, such as a merge operation.

FIG. 1 is a block diagram illustrating a system for optimizing a merge operation according to an example. The system 100 illustrated in FIG. 1 is provided for illustration only. Other examples of the system 100 can be used without departing from the scope of the present disclosure. The system 100 includes a computing device 102, a data source 112, and an external storage 116. The computing device 102 receives data, such as a dataset 114, from the data source 112, buckets, or sorts or partitions, the received dataset into one or more partitions 106, performs a merge operation, such as an UPSERT operation, with existing data, materializes an intermediate state of the partitioned data, and transmits the updated data to the external storage 116 for storage as a copy that is optimized for efficient reads in response to a query, also referred to herein as a read-optimized copy, as described in greater detail below.

The computing device 102 includes an intermediate storage 104, a communication interface 108, and an intermediate state materializer 110. In some examples, the intermediate storage 104 is a data storage device, such as a memory, that stores data. In some examples, the data is stored in a database, a data lake, a data lakehouse, and so forth. The data is stored in rows and columns comprising values of data. In some examples, the data is stored in a row store. In some examples, the data is stored in a columnar store. In some examples, each row includes at least a first value and a second value. The second value is a feature of the first value. For example, the first column includes a particular identifier (ID) and the additional columns for the row contain various values that are features of the particular ID. Thus, a first row includes data pertaining to a first ID, a second row includes data pertaining to a second ID, and so forth. In some examples, multiple records share the same ID, and therefore multiple rows are dedicated to a single ID. In some examples, each row includes tens or hundreds of columns and the ID includes multiple columns of data.

The data in the database includes one or more various types of data, including but not limited to pricing data, discount data, shipping data, address data, and so forth that is associated with a key. In some examples, the key is the merge key. In some examples, the key is a data, a timestamp, such as an hour-level timestamp, or any other suitable key with which a set of data is associated. In a non-limiting example, in a database where the ID is a user ID and a column contains values containing a city where the user associated with the user ID has a residence, a first row includes the user ID and a first residence and the second row includes the user ID and a second residence. In another examples, in a database where the first column contains values of a product ID, a second column contains values of a location where the product ID is sold, and a third column contains values of a for sale price of the product at the location, a first row includes the product ID, a first location, and a first for sale price at the first location, and a second row includes the product ID, a second location, and a second for sale price at the second location. However, it should be understood these examples are presented for illustration only and should be construed as limiting. Various examples and amounts of IDs and associated values may be used without departing from the scope of the present disclosure. In some examples, the data includes hundreds or thousands of rows and hundreds or thousands of columns.

The intermediate storage 104 includes a plurality of partitions 106. For example. FIG. 1 illustrates a first partition 106a, a second partition 106b, and an nth partition 106n. However, in various examples the intermediate storage 104 includes any number of partitions 106 suitable for storing the data of the dataset stored in the intermediate storage 104. The intermediate storage 104 stores data received from the data source 112 in the partitions 106 based on a feature value, such as the ID. For example, when an initial dataset, such as a first dataset 114a is received, the intermediate state materializer 110 identifies the IDs present in the first dataset 114a and separates the data in the received first dataset 114a into the partitions 106 using a partition scheme such that data pertaining to a first ID in the first dataset 114a is stored in the first partition 106a, data pertaining to a second ID in the first dataset 114a is stored in the second partition 106b, and data pertaining to a third ID in the first dataset 114a is stored in the nth partition 106n. In some examples, the intermediate state materializer 110 maintains a record of the particular IDs stored in the respective partitions 106 or an algorithm to derive such ID-to-bucket mappings. However, it should be understood that some datasets contain a number of unique IDs such that each ID having a separate partition 106 is not feasible. Therefore, some partitions 106 may include more than one ID and its respective values without departing from the scope of the present disclosure. In examples where it is not feasible for each ID to have a separate partition 106, range or hash bucketing is implemented.

In some examples, the number of partitions 106 is dynamic, or tunable, once a sufficient amount of data has been ingested from the data source 112 and key-partitioning mapping has been fixed. For example, based on a new dataset 114 being received that includes new IDs, additional partitions 106 are dynamically added to accommodate the newly received data in the new dataset 114. As another example, due to data from a particular partition 106 being deleted, such as part of a DELETE operation, the partition 106 is dynamically deleted. By dynamically tuning the number of partitions 106 within the intermediate storage 104, the number of operations that are able to be completed within the partition 106 is maximized. This reduces the number of computing resources and time required to perform the respective operations by minimizing a shuffling of data, which exchanges data over a network across distributed nodes. That is, the amount of network bandwidth for transmitting and receiving the data among the nodes is reduced.

When a next dataset is received from the data source 112, such as the second dataset 114b, the intermediate state materializer 110 identifies the IDs present in the second dataset 114b and automatically identifies the data in the received second dataset 114b to be merged into the partitions 106 according to the partition scheme established when the first dataset 114a was partitioned. In other words, the intermediate state materializer 110 receives the second dataset 114b, identifies ID in the second dataset 114b, matches the identified ID in the record of IDs stored in the partitions 106, and performs a merge operation to merge the records associated with the identified ID in the second dataset 114b with the records associated with the identified ID from the first dataset 114a stored in the respective partition 106. For example, Table 1 below represents an example first dataset 114a received from the data source 112 and stored in the partitions 106 of the intermediate storage 104, and Table 2 below represents an example second dataset 114b received from the data source 112 to be merged with the first dataset 114a stored in the partitions 106 of the intermediate storage 104.

TABLE 1

| Customer ID | City | Value |
|---|---|---|
| 1 | Seattle | 1 |
| 1 | Portland | 2 |
| 1 | New York | 3 |
| 2 | Seattle | 2 |

TABLE 2

| Customer ID | City | Value |
|---|---|---|
| 1 | Seattle | 2 |
| 1 | Chicago | 2 |
| 3 | Seattle | 5 |

The examples of Table 1 and Table 2 represent customers, identified by a Customer ID in a first column, with an associated city, identified by City in a second column, and an associated value, identified by a value in a third column. For example, in the first dataset 114a, a first customer ID “1” is associated with Seattle having a value of “1”, with Portland having a value of “2”, and New York having a value of “3”, while a second customer ID “2” is associated with Seattle having a value of “2”. When the intermediate state materializer 110 receives the first dataset 114a, the rows including data for customer ID “1” are stored in the first partition 106a and the row including data for customer ID “2” is stored in the second partition 106b. In some examples, the intermediate state materializer 110 stores, or saves, a record of which customer IDs are stored in which partition 106.

As referenced herein, each dataset includes a first value and a second value. In Table 1, {“Customer ID”=“1”} represents a first value, while {“City”=“Portland”} represents a second value and {“Value”=“2”} represents an nth value. The second value and the nth value are each features of the first value. In some examples, Table 1 represents a first iteration of each of the first, second, and nth values. Table 2 is a second dataset that includes additional iterations of the first, second, and nth values. For example, in the second iteration of the data in Table 2, {“Customer ID”=“1”} still represents the first value but while {“City”=“Chicago”} represents a second iteration of the second value. In other words, {“City”=“Chicago”} in Table 2 is an updated value for {“Customer ID”=“1”} originally represented in Table 1.

When the second dataset 114b is received from the data source 112, the data stored in the intermediate storage 104 is to be updated with the newly received data contained in the second dataset 114b. In some examples, the intermediate state materializer 110 performs an UPSERT operation that updates existing data in the intermediate storage 104 and inserts new data that is not previously existing in the intermediate storage 104. For example, where the data in Table 2 is received as the second dataset 114b, the data regarding the customer ID “1” updates the existing data for customer ID “1” and the data regarding customer ID “3” is inserted into the intermediate storage 104 and stored in a partition, such as the nth partition 106n. The second dataset 114b includes no data associated with customer ID “2”, so the data associated with customer ID “2” stored from the first dataset 114a is unchanged. The UPSERT operation is described in greater detail below. Following the UPSERT operation, the updated data stored in the intermediate storage 104 is represented by Table 3 below.

TABLE 3

| Customer ID | City | Value |
|---|---|---|
| 1 | Seattle | 2 |
| 1 | Chicago | 2 |
| 2 | Seattle | 2 |
| 3 | Seattle | 5 |

As can be seen in Table 3, the data associated with customer ID “1” from the first dataset 114a in Table 1 has been updated with the data associated with customer ID “1” from the second dataset 114b in Table 2, the data associated with customer ID “2” from the first dataset 114a in Table 1 has been unchanged due to no updated data regarding customer ID “2” being received in the second dataset 114b, and the data associated with customer ID “3” from the second dataset 114b has been inserted into the intermediate storage 104.

In some examples, the data stored in the intermediate storage 104 is updated with each new dataset 114 received from the data source 112. In some examples, an Nth dataset 114n is received that updates the data stored as Table 3.

At the completion of each merge operation, such as the UPSERT operation, the intermediate state materializer 110 materializes the state of the data. The materialized state is transmitted to the external storage 116 via the communication interface 108 and converted to a read-optimized copy that, upon receipt of a query, is returned in a form as requested by the query. For example, the materialized state is transformed into a target partition in the read-optimized copy on the external storage 116 that complies with target partitioning of the data. In some examples, the external storage 116 maintains the read-optimized copy of the materialized intermediate state of the partitioned data for efficient recall in response to a query. For example, the read-optimized copy is pre-sorted and partitioned for optimal reads. For example, the data is partitioned such that where a query for the data sorted by “City” is received, the data returned is sorted by the “City” value, as shown below in Table 4.

TABLE 4

| Customer ID | City | Value |
|---|---|---|
| 1 | Seattle | 2 |
| 2 | Seattle | 2 |
| 3 | Seattle | 5 |
| 1 | Chicago | 2 |

As illustrated in Table 4, the same data is presented as in Table 3, but the representation of the data in Table 4 is sorted, or grouped, by the “City” value, which was specified as the merge key in the received query. In some examples, the data is pre-sorted and partitioned such that a query for the data sorted by “Customer ID” is presented as stored in Table 3. In some examples, the data is pre-sorted and partitioned such that a query for the data sorted by “Value” returns data sorted by “Value”.

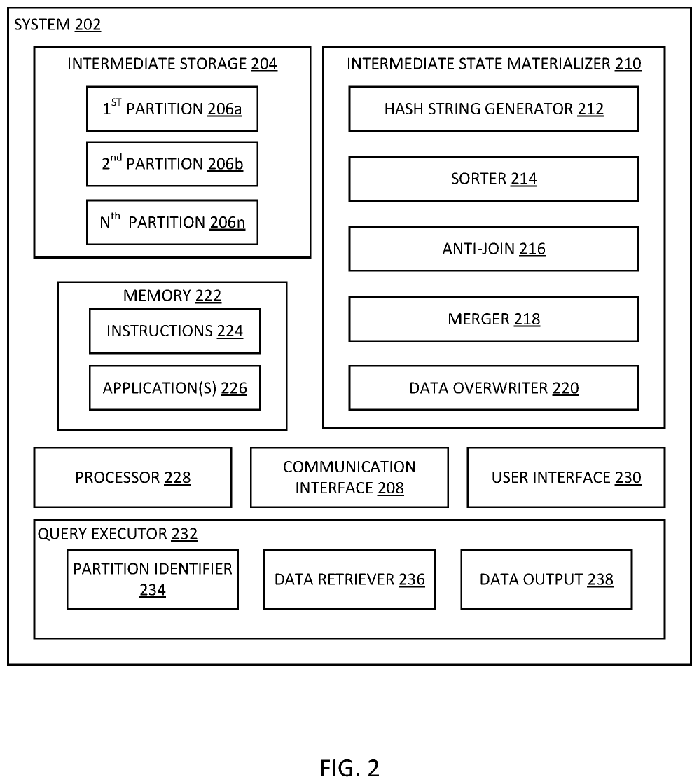

FIG. 2 is a block diagram illustrating a system for optimizing a merge operation according to an example. The system 202 illustrated in FIG. 2 is provided for illustration only. Other examples of the system 202 can be used without departing from the scope of the present disclosure. In some examples, the system 202 is an example of the computing device 102 illustrated in FIG. 1.

The system 202 includes an intermediate storage 204, an intermediate state materializer 210, a communication interface 208, a memory 222, a processor 228, and a user interface 230. The memory 222 stores instructions 224 executed by the processor 228 to control the communications interface 208, the intermediate storage 204, and the intermediate state materializer 210. The memory 222 further stores data, such as one or more applications 226. An application 226 is a program designed to carry out a specific task on the system 202. For example, the applications 226 may include, but are not limited to, virtual computing applications. IoT device management applications, payment processing applications, drawing applications, paint applications, web browser applications, messaging applications, navigation/mapping applications, word processing applications, gaming applications, video applications, an application store, applications included in a suite of productivity applications such as calendar applications, instant messaging applications, document storage applications, video and/or audio call applications, and so forth, and specialized applications for a particular system 200. In some examples, the applications 226 communicate with counterpart applications or services, such as web services. The processor 228 executes the instructions 224 stored on the memory 222 to perform various functions of the system 202, such as the communications interface 208, the intermediate storage 204, and the intermediate state materializer 210.

In some examples, the intermediate storage 204 is an example of the intermediate storage 104, the intermediate state materializer 210 is an example of the intermediate state materializer 110, and the communication interface 208 is an example of the communications interface 108. The intermediate storage 204 includes a first partition 206a, a second partition 206b, and an nth partition 206n which may be the first partition 106a, the second partition 106b, and the nth partition 106n, respectively.

The intermediate state materializer 210 is a specialized processing unit, implemented on the processor 228, that includes a hash string generator 212, a sorter 214, an anti-join portion 216, a merger portion 218, and a data overwriter 220. The hash string generator 212, sorter 214, anti-join portion 216, merger portion 218, and data overwriter 220 are each specialized processing units implemented on the intermediate state materializer 210 that perform specialized processing functions. In some examples, anti-join merger 216 and merger portion 218 are combined into a single element (e.g., ‘apply merge logic’), such that the operations of each element are performed as one operation atomically. The hash string generator 212 reads upstream data, in other words data that is received from the data source 112, and generates a hash string for the received data. The sorter 214 executes processing logic to partition the incoming data into one of the partitions 206 and the anti-join portion 216 and merger portion 218 perform separate functions that collectively form the merge operation, such as an USPERT operation. In some examples, the partitioning is referred to as bucketing or sorting. The data overwriter 220 overwrites the relevant data to reflect the changes to the stored data following the merge operation, which persists an intermediate snapshot of the data partitioned by the merge key. As referenced herein, the merge key is the key value in which records that have the same key value are merged. In the example of Tables 1 and 2 above, the merge key is the customer ID, because incoming, or received, records that have the same customer ID as existing records are updated.

The hash string generator 212 generates a hash string for received data from the data source 112, such as one of the received datasets 114. For example, the hash string is generated for the ID and stored as a record in the memory 222 for identification of the particular IDs stored in the respective partitions 206. In other examples, a hash string is generated for a combination of multiple columns. For example, where the data is related to a product, separate hash strings are generated for columns in the dataset related to a commerce root ID, a billing group ID, a rating asset ID, and a rating period ID.

The sorter 214 re-sorts, or re-buckets or re-partitions, the received data based on the merge key hash into the partitions 206. For example, the sorter 214 matches the hash string or strings stored as records in the memory 222 for existing data with newly generated hash strings for incoming data in a received dataset 114. By matching the new hash string to a stored hash string, the sorter 214 sorts the incoming data according to the existing partition scheme, reducing the amount of computing resources and time required to perform the merge operation based on the merge key.

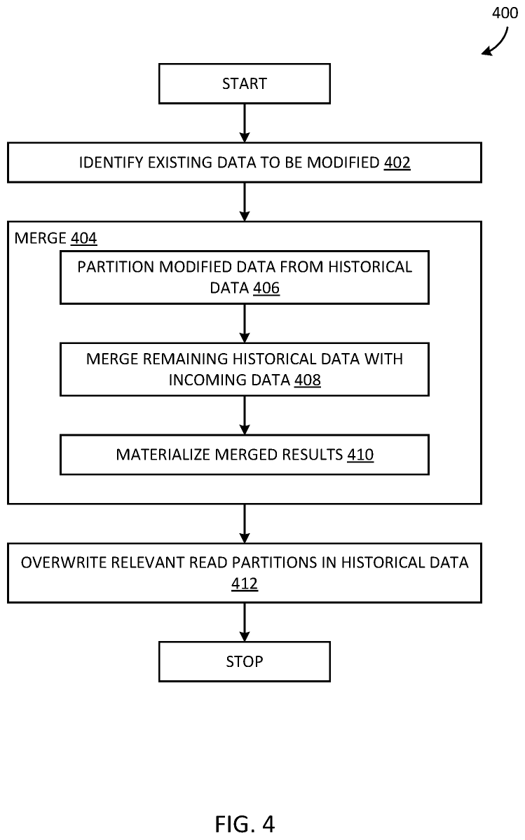

Each of the anti-join portion 216 and the merger portion 218 are specialized processing units implemented on the intermediate state materializer 210 that perform specialized processing functions that execute a merge operation between existing data stored in one or more of the partitions 206 and newly received data. For example, in a merge operation that is an UPSERT operation, the anti-join portion 216 performs a left-anti join operation to remove modified records from historical data. The merger portion 218 executes the union between the existing data and the newly received data, and persists an intermediate snapshot of the joined-and-unioned data. In some examples, the intermediate snapshot is persisted in a parquet format partitioned by the merge key. However, various formats are possible and may be used without departing from the scope of the present disclosure. The merge operation is described in greater detail below in the description of FIG. 4.

The data overwriter 220 uses the intermediate persisted snapshot to overwrite the relevant read partitions 206 in the stored data. In some examples, the intermediate persisted snapshot is used for subsequent iterations of a join with incoming data, which avoids a reshuffling of historical data at each instance of the merge operation. This reduces the amount of computing resources and time required to perform the merge operation, as well as prevents an inconsistent state from being presented in response to a query in the event a query is received prior to the completion of a merge operation.

Following the data overwriter 220 overwriting the relevant read partitions 206 to reflect the updated or inserted data in the partitions 206, the communication interface transmits the stored data in the partitions 206 to an external storage environment, such as the external storage 116, where the data is saved. The intermediate state materializer 210 then pulls the saved data in response to a query and resorts the saved data based on a key included in the query. The system 202 outputs the results of the query, such as on the user interface 230 or an external device.

The user interface 230 is presented on a display of the system 202. In some examples, the user interface 230 illustrates an example of an application 226 that is used to execute a query or perform the merge operation. In some examples, the application 226 is accessed by a user via the user interface in order to input a query and display the results of the query, as described in greater detail below in the description of FIG. 6.

The system 202 further includes a query executor 232 that receives and responds to queries that request that request data stored in the external storage 116. The query executor 232 includes a partition identifier 234, a data retriever 236, and a data output portion 238. The partition identifier 234 identifies within which partition or partitions 206 the queried data is stored. The data retriever 236 retrieves the queried data from the identified partition or partitions 206 and sorts the retrieved data. In some examples, the data retriever 236 sorts the retrieved data according to a specified key included in the received query. In some examples, the data retriever 236 sorts the retrieved data according to a default merge key, such as the ID of the data. The data output portion 238 outputs the retrieved and sorted data via the interface where the query was received. For example, the retrieved and sorted data is output via the communication interface 208 where the query was received via the communication interface 208 and output via the user interface 230 where the query was received via the user interface 230.

In some examples, the system 202 is implemented as a single computing device that includes each of the components of the system 202. In other examples, the system 202 is implemented as multiple devices that collectively are referred to as the system 202. In some examples, the intermediate storage 204 is provided as more than one computing device, such as a server, in order to include a sufficient amount of storage capacity to store the datasets of each of the partitions 206. In some examples, one or more aspects of the system 202 are implemented as a cloud-implemented server that includes each of the components of the system 202 described herein.

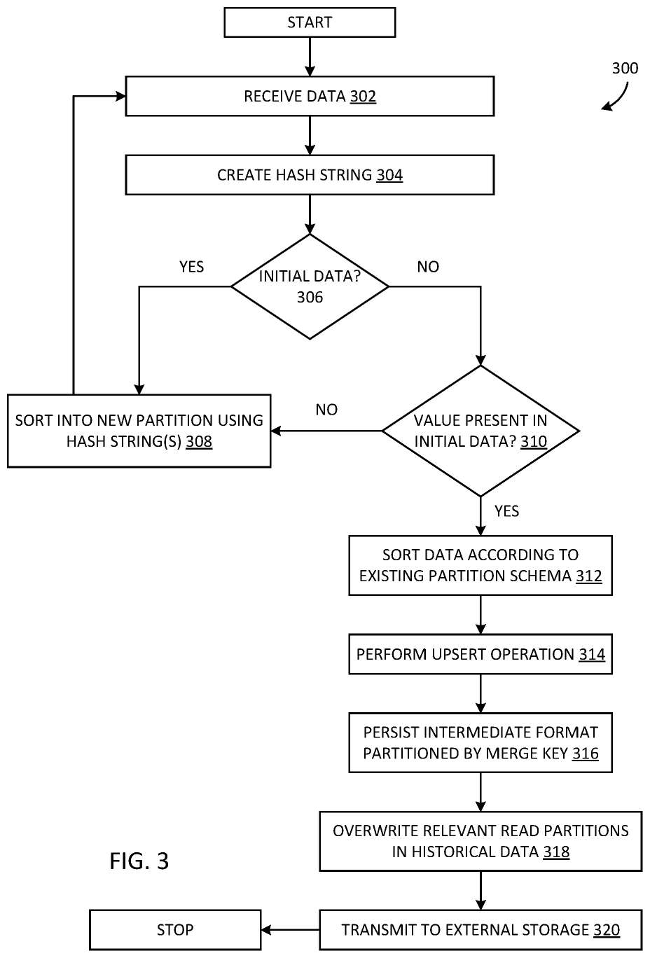

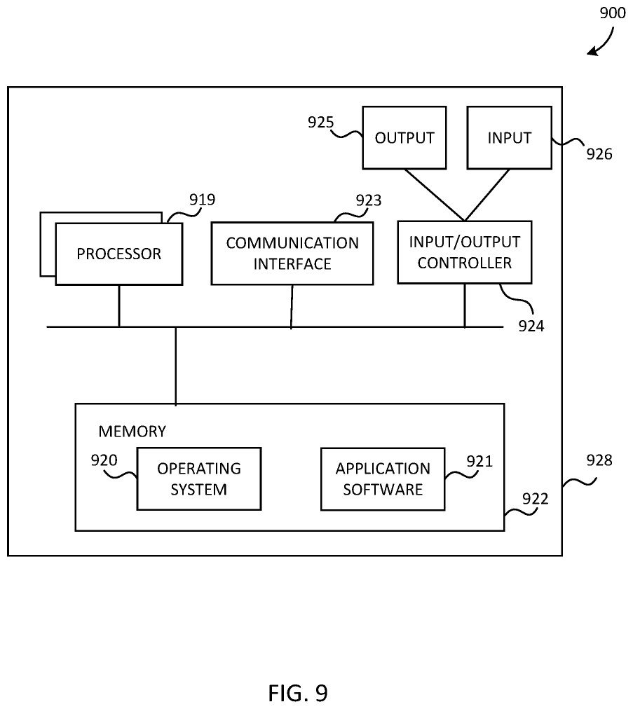

FIG. 3 is a flowchart illustrating a computerized method for partitioning incoming data according to an example. The method 300 illustrated in FIG. 3 is for illustration only. Other examples of the method 300 can be used without departing from the scope of the present disclosure. The method 300 can be implemented by one or more components of the system 100 illustrated in FIG. 1, such as the components of the computing apparatus 928 described in greater detail below in the description of FIG. 9. In particular, the steps of the method 300 can be executed by the processor 919 of the computing apparatus 928.

The method 300 begins by the intermediate state materializer 210 receiving data from a data source, such as the data source 112, in operation 302. In some examples, the received data is a dataset 114, such as the first dataset 114a. In operation 304, the intermediate state materializer 210 creates a hash string that identifies the received dataset and a hash string for each identifier of the received first dataset 114a. Each hash string is generated for an ID of and stored as a record in the memory 222 to indicate in which partition 206 the particular identifier is partitioned into.

In operation 306, the intermediate state materializer 210 determines whether each record in the received dataset 114a is a value that is present in the initial data. To determine whether the particular value is present in the initial dataset, the intermediate state materializer 210 compares the generated hash string for the particular ID to the hash strings present in the initial data. In some examples, where the values are not present in the initial data, the intermediate state materializer 210 sorts the value into a new partition using the hash string in operation 308. In some examples, where the values are not present in the initial data, the intermediate state materializer 210 sorts the value into an existing partition. The intermediate state materializer 210 sorts the value into an existing or new partition based on the bucketing algorithm implemented to sort the values. In some examples, each separate ID is partitioned into a separate partition 206 such that a single partition 206 contains all the records for a single ID. In other examples, a predefined number of IDs are partitioned into each partition 206. Where the values are present in the initial data, the intermediate state materializer 210 proceeds sorts the data according to the existing partition scheme in operation 310. For example, as shown above in Tables 1 and 2, where the customer ID “1” from Table 2 is identified as present in the initial dataset in Table 1, the values for customer ID “1” are partitioned into the partition 206 in which customer ID “1” are already partitioned.

In operation 312, the intermediate state materializer 210 performs an UPSERT operation to update existing data in the partitions 206 with newly received data or insert newly received data that did not previously exist in the intermediate storage 204. In some examples, the UPSERT operation includes an anti-join operation to remove modified records from historical data and a union operation between the existing data and the newly received data. The USPERT operation concludes by persisting an intermediate snapshot of the joined-and-unioned data in operation 314. As described above, Table 1 is an example of an initial dataset on which the UPSERT operation is performed using the updated dataset received as Table 2, and the resulting dataset is Table 3. In some examples, the intermediate snapshot, such as represented in Table 3, is persisted in a parquet format partitioned by the merge key.

In operation 316, the data overwriter 220 overwrites the relevant read partitions 206 in the historical data. In some examples, the relevant read partitions 206 include any data that has been changed in the UPSERT operation. In other words, any data values that have been updated from the initial dataset or inserted into the initial dataset. In the example above, where the initial dataset is represented by and the intermediate snapshot is represented by Table 3, the relevant read portions that are overwritten include the removal of rows {Customer ID=1, City=Seattle, Value=1} {Customer ID=1, City=Portland, Value=2} and {Customer ID=1, City=New York, Value=3} and the addition of the row {Customer ID=3, City=Seattle, Value=5} and {CustomerID=1, City=Seattle, Value=2}. In operation 318, the communication interface 208 transmits the final, saved data to the external storage 116.

FIG. 4 is a flowchart illustrating a computerized method for performing an update an insert operation according to an example. The method 400 illustrated in FIG. 4 is for illustration only. Other examples of the method 400 can be used without departing from the scope of the present disclosure. The method 400 can be implemented by one or more components of the system 100 illustrated in FIG. 1, such as the components of the computing apparatus 928 described in greater detail below in the description of FIG. 9. In particular, the steps of the method 500 can be executed by the processor 919 of the computing apparatus 928.

The method 400 begins by the sorter 214 identifying existing data to be modified in operation 402. For example, the existing data to be modified is data, previously received as a first dataset 114a, that has been partitioned into the partitions 206. In operation 404, the intermediate state materializer 210 performs a merge operation. For example, in operation 406, the anti-join portion 216 partitions modified records from the historical data, i.e., the existing data, in preparation for new data to be added to update the data. In some examples, the anti-join portion 216 removes the modified records from the historical by executing a left-anti join operation.

In operation 408, the merger portion 218 merges the remaining historical data, that was not removed in operation 402, with the incoming data. In some examples, merging the remaining historical data with the incoming data includes adding the incoming data to the existing historical data. For example, to merge the remaining historical data with the incoming data, the merger portion 218 adds new rows of data to the existing data that include the data from the incoming data. The new rows of data from the incoming data effectively replace the data that is removed in operation 406 with the new; updated data included in the incoming dataset.

In operation 410, the merger portion 218 materializes the merged data. The new incoming data is added as new rows of data to the existing data. It should be understood that although described herein as two separate steps, in various examples operations 408 and 410 are performed as a single operation, operation 408 is performed prior to operation 410 being performed, or operation 410 is performed prior to operation 408 being performed. In other words, operations 408 and 410 may be performed together without departing from the scope of the present disclosure. In some examples, following the completion of operations 408 and 410, the merger portion 218 persists an intermediate snapshot of the joined and unioned data.

It should be understood that although described herein as three separate operations occurring in sequence, in some examples operations 406-410 occur as a single step by which the existing historical data is merged with new, incoming data. In some examples, the operations 406-410 are collectively referred to as the merge operation 404, which includes removing old data to be modified and merging the existing data with incoming data by adding the new data.

In operation 412, the data overwriter 220 overwrites the relevant read partitions 206 in the stored historical data. In other words, the data overwriter 220 overwrites the data that has been updated and/or inserted since a most recent iteration of the method 400. In some examples, the intermediate persisted snapshot is used for subsequent iterations of a join with incoming data, which avoids a reshuffling of historical data at each instance of the merge operation. This reduces the amount of computing resources and time required to perform the merge operation, as well as prevents an inconsistent state from being presented in response to a query in the event a query is received prior to the completion of a merge operation.

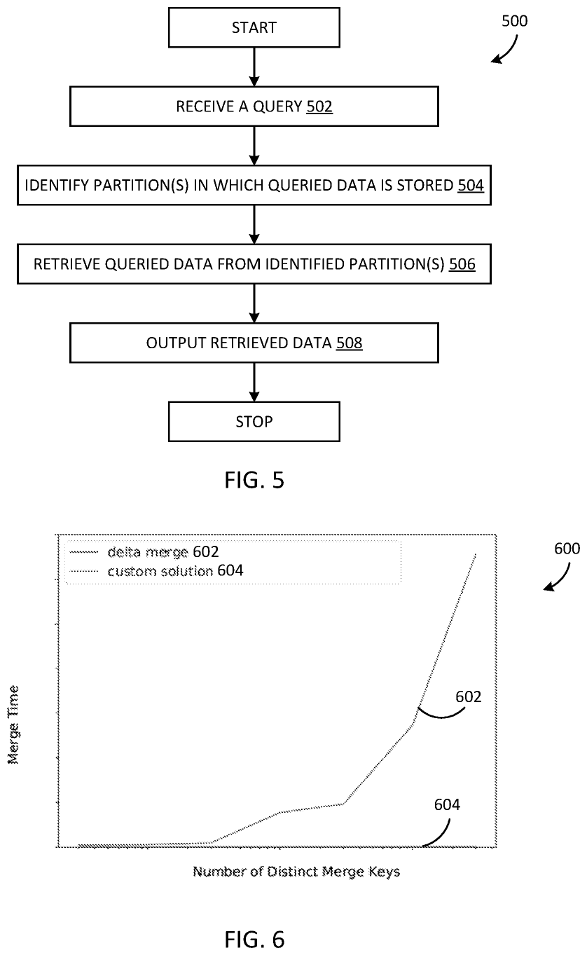

FIG. 5 is a flowchart illustrating a computerized method for responding to a query using the partitioned data according to an example. The method 500 illustrated in FIG. 5 is for illustration only. Other examples of the method 500 can be used without departing from the scope of the present disclosure. The method 500 can be implemented by one or more components of the system 100 illustrated in FIG. 1, such as the components of the computing apparatus 928 described in greater detail below in the description of FIG. 9. In particular, the steps of the method 500 can be executed by the processor 919 of the computing apparatus 928.

The method 500 begins by the query executor 232 receiving a query in operation 502. In some examples, the query is a request to present a particular selection of the data at a point in time. For example, the data requested may include all data that includes a particular value, all data related to a particular ID, and so forth. In some examples, the query is received via an application 226 presented on the user interface 230. In other examples, the query is received from an external device and received via the communication interface 208. In some examples, the query is input by a user of the system 202. In other examples, the query is received as an aspect of an application 226 executing in the system 202. In some examples, the received query includes a merge key that specifies by which value of the data the returned data, in response to the query, is to be sorted. In an example query for the data contained in Table 3 above, the query is for all data related to customer IDs 1, 2, and 3 sorted by the “city” value, and the merge key is the “city” value because that is the value by which the data is requested to be sorted.

In operation 504, the partition identifier 234 identifies which partition or partitions 206 that queried data is stored in within the read-optimized copy stored in the external storage 116. In examples where the query is for all data that includes a particular value, the partition identifier 234 determines to scan each of the partitions 206 in the read-optimized copy for the queried data. In examples where the query is for all data related to a particular ID or IDs, the partition identifier 234 identifies which partition or partitions 206 of the read-optimized copy the ID or IDs requested are stored. In these examples, the partition identifier 234 isolates the particular partitions 206 which are to be scanned to extract the queried data, which reduces the amount of computing resources and time required to respond to the query. In the example where the example query is for all data related to customer IDs 1, 2, and 3 sorted by the “city” value, the partition identifier 234 identifies all the partitions 206 in which data related to customer IDs 1, 2, and 3 are stored.

In operation 506, the data retriever 236 retrieves the queried data from the identified partition or partitions 206. In the example above where the example query is for all data related to customer IDs 1, 2, and 3 sorted by the “city” value, the data retriever 236 retrieves all the data for customer IDs 1, 2, and 3, which as shown in Table 3 includes “city” and “value” data for each of customer IDs 1, 2, and 3. In operation 508, the data output portion 238 outputs the retrieved and partitioned data via the interface where the query was received. For example, the retrieved and sorted data is output via the communication interface 208 where the query was received via the communication interface 208 and output via the user interface 230 where the query was received via the user interface 230. In the example above where the example query is for all data related to customer IDs 1, 2, and 3 sorted by the “city” value, the data output portion 238 outputs the retrieved and partitioned data in the format of Table 4 above. In other words, the output data is sorted, or grouped, by the “City” value, which was specified as the merge key in the received query.

### Example Test Results

FIG. 6 illustrates test results utilizing the optimized merge operation as described herein. In the example 600 illustrated in FIG. 6, ninety percent of the received data is used to update the initial dataset and ten percent of the received data does not correspond to data present in the initial dataset and therefore is inserted during the UPSERT operation. The example 600 illustrates merge time as a function of the number of distinct merge keys. As shown in the example 600, a solution 604 as described in the present disclosure completes the same operation as an existing solution 602 using delta merge 387 times faster as the number of distinct merge keys increases at the same rate as in the existing solution.

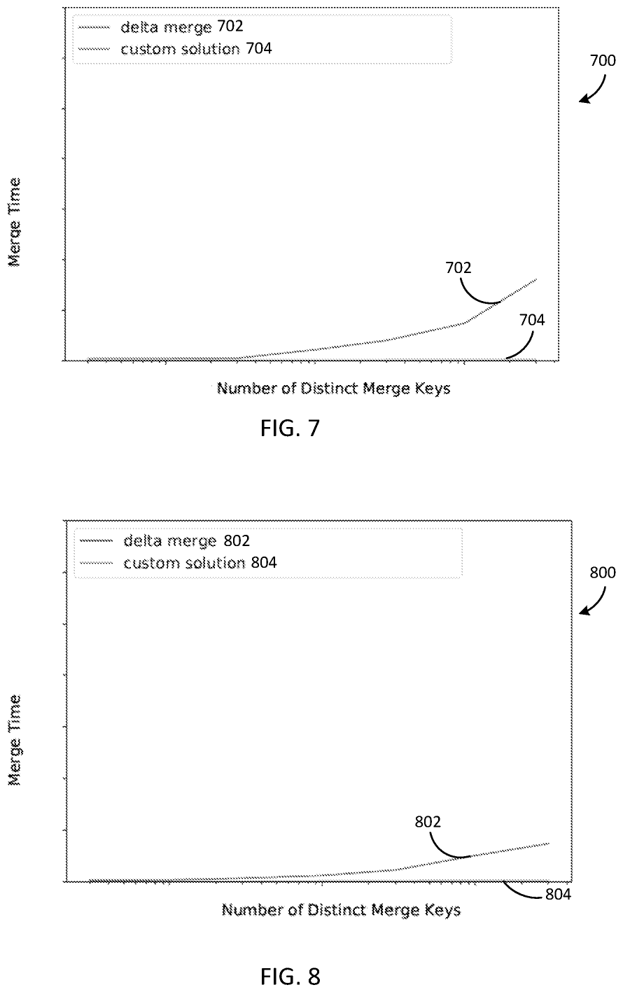

As another example, FIG. 7 illustrates test results utilizing the optimized merge operation as described herein. In the example 700 illustrated in FIG. 7, thirty percent of the received data is used to update the initial dataset and seventy percent of the received data does not correspond to data present in the initial dataset and therefore is inserted during the UPSERT operation. The example 700 illustrates merge time as a function of the number of distinct merge keys. As shown in the example 700, a solution 704 as described in the present disclosure completes the same operation as an existing solution 702 using delta merge 89 times faster as the number of distinct merge keys increases at the same rate as in the existing solution.

As another example, FIG. 8 illustrates test results utilizing the optimized merge operation as described herein. In the example 800 illustrated in FIG. 8, ten percent of the received data is used to update the initial dataset and ninety percent of the received data does not correspond to data present in the initial dataset and therefore is inserted during the UPSERT operation. The example 800 illustrates merge time as a function of the number of distinct merge keys. As shown in the example 800, a solution 804 as described in the present disclosure completes the same operation as an existing solution 802 using delta merge 42 times faster as the number of distinct merge keys increases at the same rate as in the existing solution.

### Exemplary Operating Environment

The present disclosure is operable with a computing apparatus according to an example as a functional block diagram 900 in FIG. 9. In an example, components of a computing apparatus 928 may be implemented as a part of an electronic device according to one or more examples described in this specification. For example, the computing apparatus 928 can be the computing device 102 illustrated in FIG. 1. The computing apparatus 928 comprises one or more processors 919 which may be microprocessors, controllers, or any other suitable type of processors for processing computer executable instructions to control the operation of the electronic device. Alternatively, or in addition, the processor 919 is any technology capable of executing logic or instructions, such as a hardcoded machine. Platform software comprising an operating system 920 or any other suitable platform software may be provided on the apparatus 928 to enable application software 921 to be executed on the device.

Computer executable instructions may be provided using any computer-readable media that are accessible by the computing apparatus 928. Computer-readable media may include, for example, computer storage media such as a memory 922 and communications media. Computer storage media, such as a memory 922, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 922) is shown within the computing apparatus 928, it will be appreciated by a person skilled in the art, that the storage may be distributed or located remotely and accessed via a network or other communication link (e.g., using a communication interface 923). For example, the communication interface 923 can transmit the materialized intermediate state to the external storage 116.

In some examples, the computer-readable media includes instructions that, when executed by the processor 919, execute instructions for the intermediate state materializer 110, the intermediate storage 104, and the communication interface 108.

The computing apparatus 928 may comprise an input/output controller 924 configured to output information to one or more output devices 925, for example a display or a speaker, which may be separate from or integral to the electronic device. For example, the output device 925 can be a user interface. The input/output controller 924 may also be configured to receive and process an input from one or more input devices 926, for example, a keyboard, a microphone, or a touchpad. In some examples, the one or more input devices 926 is an input reception module. In one example, the output device 925 may also act as the input device. An example of such a device may be a touch sensitive display that functions as both the input/output controller 924. The input/output controller 924 may also output data to devices other than the output device, e.g., a locally connected printing device. In some examples, a user may provide input to the input device(s) 926 and/or receive output from the output device(s) 925.

The functionality described herein can be performed, at least in part, by one or more hardware logic components. According to an example, the computing apparatus 928 is configured by the program code when executed by the processor 919 to execute the examples of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for optimizing a merge operation via materialized intermediate partitions includes a processor and a memory. The memory includes computer program code. The memory and the computer program code are configured to, with the processor, cause the processor to bucket a first dataset in a database into a partition, the first dataset including a first value and a first iteration of a second value, wherein the second value is a feature of the first value, bucket a second dataset in the database into the partition, the second dataset including the first value and a second iteration of the second value, wherein the second iteration of the second value is different than the first iteration of the second value, perform an UPSERT operation that updates the partition to include the first value and the second iteration of the second value, and transmit, via a communication interface, the updated partition to an external storage.

An example computerized method for optimizing a merge operation via materialized intermediate partitions includes bucketing a first dataset in a database into a partition, the first dataset including a first value and a first iteration of a second value, wherein the second value is a feature of the first value, bucketing a second dataset in the database into the partition, the second dataset including the first value and a second iteration of the second value, wherein the second iteration of the second value is different than the first iteration of the second value, updating the partition to include the first value and the second iteration of the second value, and transmitting the updated partition to an external storage.

Examples of computer storage media have computer-executable instructions for optimizing a merge operation via materialized intermediate partitions that, upon execution by a processor, cause the processor to bucket a first dataset in a database into a partition, the first dataset including a first value and a first iteration of a second value, wherein the second value is a feature of the first value, bucket a second dataset in the database into the partition, the second dataset including the first value and a second iteration of the second value, wherein the second iteration of the second value is different than the first iteration of the second value, perform an UPSERT operation that updates the partition to include the first value and the second iteration of the second value, receive a query request, the query request including a request to return data and a merge key, sort the updated partition by the merge key; and transmit, via a communication interface, a portion of the updated partition related to the received query request.

Alternatively, or in addition to the other examples described herein, examples include any combination of the following:
receiving a query request;
outputting a portion of the updated partition;
bucketing the updated partition by the second value;
outputting a portion of the updated partition related to the received query request;
wherein updating the partition comprises performing an UPSERT operation;
merging the second dataset with the first dataset by replacing the first iteration of the second value with the second iteration of the second value;
wherein the first value is a merge key;
receiving a third dataset, the third dataset including a third value and a third iteration of the second value;
determining the third value does not match the first value;
bucketing the third dataset into a second partition;
receiving a third dataset, the third dataset including a third value and a third iteration of the second value;
determining the third value matches the first value; and
bucketing the third dataset into the first partition;
updating the partition to include the third value and the third iteration of the second value;
wherein the first value is an identifier and the second value indicates at least one of pricing data, discount data, shipping data, or address data associated with the identifier; and
wherein the partition is implemented in a distributed database storage system.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A computerized method, comprising:
bucketing a first dataset in a database into a partition, the first dataset including a first value and a first iteration of a second value, wherein the second value is a feature of the first value;
bucketing a second dataset in the database into the partition, the second dataset including the first value and a second iteration of the second value, wherein the second iteration of the second value is different than the first iteration of the second value;
updating the partition to include the first value and the second iteration of the second value; and
transmitting the updated partition to an external storage.

2. The computerized method of claim 1, further comprising:
receiving a query request; and
outputting a portion of the updated partition based on the received query request.

3. The computerized method of claim 2, wherein outputting the portion of the updated partition further comprises:
bucketing the updated partition by the second value;
outputting a portion of the updated partition related to the received query request.

4. The computerized method of claim 1, wherein updating the partition comprises performing an UPSERT operation.

5. The computerized method of claim 4, wherein performing the UPSERT operation includes:
merging the second dataset with the first dataset includes replacing the first iteration of the second value with the second iteration of the second value.

6. The computerized method of claim 4, wherein the first value is a merge key.

7. The computerized method of claim 1, further comprising:
receiving a third dataset, the third dataset including a third value and a third iteration of the second value;
determining the third value does not match the first value; and
bucketing the third dataset into a second partition.

8. The computerized method of claim 1, further comprising:
receiving a third dataset, the third dataset including a third value and a third iteration of the second value;
determining the third value matches the first value; and
bucketing the third dataset into the first partition; and
updating the partition to include the third value and the third iteration of the second value.

9. The computerized method of claim 1, wherein the first value is an identifier and the second value indicates at least one of pricing data, discount data, shipping data, or address data associated with the identifier.

10. The computerized method of claim 1, wherein the partition is implemented in a distributed database storage system.

11. A system, comprising:
a processor;
a communication interface; and
a memory storing instructions that, when executed by the processor, cause the processor to:
bucket a first dataset in a database into a partition, the first dataset including a first value and a first iteration of a second value, wherein the second value is a feature of the first value;
bucket a second dataset in the database into the partition, the second dataset including the first value and a second iteration of the second value, wherein the second iteration of the second value is different than the first iteration of the second value;
perform an UPSERT operation that updates the partition to include the first value and the second iteration of the second value; and
transmit, via a communication interface, the updated partition to an external storage.

12. The system of claim 11, wherein the communication interface is further configured to:
receive a query request; and
output a portion of the updated partition based on the received query request.

13. The system of claim 12, wherein, to output the portion of the updated partition,
the processor is further configured to bucket the updated partition by the second value; and
the communication interface is further configured to output a portion of the updated partition related to the received query request.

14. The system of claim 11, wherein, to perform the UPSERT operation, the processor is further configured to:
merge the second dataset with the first dataset including replacing the first iteration of the second value with the second iteration of the second value.

15. The system of claim 11, wherein the first value is a merge key.

16. The system of claim 11, wherein the processor is further configured to:
receive a third dataset, the third dataset including a third value and a third iteration of the second value;
determine the third value does not match the first value; and
bucket the third dataset into a second partition.

17. The system of claim 11, wherein the processor is further configured to:
receive a third dataset, the third dataset including a third value and a third iteration of the second value;
determine the third value matches the first value; and
bucket the third dataset into the first partition; and
update the partition to include the third value and the third iteration of the second value.

18. A computer-readable medium storing instructions that, when executed by a processor, cause the processor to:
bucket a first dataset in a database into a partition, the first dataset including a first value and a first iteration of a second value, wherein the second value is a feature of the first value;
bucket a second dataset in the database into the partition, the second dataset including the first value and a second iteration of the second value, wherein the second iteration of the second value is different than the first iteration of the second value;
perform an UPSERT operation that updates the partition to include the first value and the second iteration of the second value;
receive a query request, the query request including a request to return data and a merge key;
bucket the updated partition by the merge key; and
transmit, via a communication interface, a portion of the updated partition related to the received query request.

19. The computer-readable medium of claim 18, further storing instructions that, when executed by the processor, further cause the processor to:
receive a third dataset, the third dataset including a third value and a third iteration of the second value;
determine the third value does not match the first value; and
bucket the third dataset into a second partition.

20. The computer-readable medium of claim 18, further storing instructions that, when executed by the processor, further cause the processor to:
receive a third dataset, the third dataset including a third value and a third iteration of the second value;
determine the third value matches the first value; and
bucket the third dataset into the first partition; and
update the partition to include the third value and the third iteration of the second value.
